(19) United States
(12) Patent Application Publication
(10) Pub. No.: US 2026/0186793 A1
(43) Pub. Date: Jul. 2, 2026

(54) METHOD FOR CONTROLLING DISCRETE EVENT SYSTEMS

(71) Applicant: OVOCHAIN, Marseille (FR)

(72) Inventor: William FAMY, Saint-Martin-De-Crau (FR)

(73) Assignee: OVOCHAIN, Marseille (FR)

(21) Appl. No.: 18/729,957

(22) PCT Filed: Jan. 20, 2023
(86) PCT No.: PCT/FR2023/050083

§ 371 Date: Jul. 18, 2024

(30) Foreign Application Priority Data
Jan. 20, 2022 (FR) FR2200468

(51) Int. Cl. G06F 9/448

(52) U.S. Cl. CPC G06F 9/4488

(57) ABSTRACT

The invention relates to a method, implemented by a computer infrastructure, for controlling the sequential change in a resource of a discrete event system, said change being modelled by a state machine having a plurality of states and at least one transition for changing the current state of the resource from a first state to a second state on the occurrence of a predefined event, the method comprising the following steps: reading a first computer object representing the resource, said first computer object describing the current state of the resource and comprising a function that is intended to be executed automatically by the computer infrastructure in the event of a request to change the current state of the resource from the first state to the second state; executing the function associated with the requested state transition from the first state to the second state.

The present invention relates to discrete event systems, and more particularly to methods for controlling the sequential evolution of the resources of such systems.

By discrete event system is meant here any system which evolves over time due to the occurrence of events or, in contrast to a continuous system, any system the evolution of which need not be observed continuously, but only when predefined events occur. These systems are characterized by a discrete space of states and transitions, in jumps and not in a continuous manner, for implementing respectively, when predefined events occur, a change of the current state of resources from a first state to a second state. Because of this, state-transition models or diagrams or event graphs are often used to control these discrete event systems, such as a finite state machine, a Grafcet, a Petri net, a UML (“Unified Modeling Language”) activity diagram or an algebraic model, such as “max-plus” algebra.

The dynamic of a discrete event system corresponds to the sequential evolution of its resources by sequencing the states thereof by transitions according to a process (or workflow) governed by the occurrence of isolated events. These events comprise logical conditions such as the detection of a signal, the entering of an input parameter by a user of the system, the completion of a task, a change of value of an item of data or, more generally, the verification of at least one condition internal or external to the system.

Computer implementations of discrete event systems exist. By way of example, the document “Maar HAMRI et al. “Discrete event design patterns” DOI 10.1145/2486092.2486138, ISBN: 978-1-4503-2193-8, 19/05/2013s” discloses an object-oriented implementation which is focused on the event according to which, as a function of the produced event and the current state of a finite state machine, an instance of an event object determines the next state of said finite state machine. Such a document moreover discloses an alternative embodiment according to which a pair (produced event, current state of the finite state machine) selects a transition to be triggered, which in turn modifies the following state of said machine. The document EP2182435A1 for its part discloses a programming mode of a finite state machine according to which an object can successively adopt several states defined by said finite state machine following events and can designate a function the execution of which can be triggered during the transition from a first state to a second state. Furthermore, central or distributed databases are generally provided to record or retrieve data of the system.

A drawback of the existing modelling of discrete event systems is that it leads to implementations peculiar to each system, including for substantially similar systems. For example, online ticketing systems or, more generally, online sales systems often have, irrespective of the goods offered for sale, the same state space characterizing respectively the resources, in this case reservation tickets for a ticketing system, and transitions between these states. However, they translate into as many implementations of systems as there are goods offered for sale.

This results in a multiplication of the computer resources needed to implement different systems as well as similar ones, an overloading of the databases hosting the data of these systems, as well as a number of drawbacks which result from this, such as the security of the data taking into account their heterogeneity, the maintenance of such systems or the carbon impact of the computer infrastructures for implementing them. Furthermore, all of the applications likely to require changes of current states of resources of such systems must comply with, i.e. be developed to satisfy, state transition policies that are often different from one resource to another or from one system to another. Such applications are therefore, at the present time, not capable of contributing to the evolution of a plurality of resources affected by different evolution criteria or policies. This results in a number of redundant developments of applications and an almost impossible interoperability for contributing to the evolution of resources of different discrete event systems.

A subject of the present invention is to facilitate and optimize the control of discrete event systems.

Another subject of the present invention is to propose methods for controlling the sequential evolution of resources of discrete event systems, said resources driving their evolution autonomously in response to requests to change their current state.

Another subject of the present invention is to improve the control of discrete event systems by acting on their modelling to facilitate the deployment of a number of resources having the same sequential evolution criteria and to give them an autonomous and homogeneous control of their respective evolutions whichever applications require such an evolution.

Another subject of the present invention is to propose a method for controlling the sequential evolution of a resource of at least one discrete event system in response to requests to change the current state of this resource from a first state to a second state of the machine modelling this resource.

To this end, firstly, a method is proposed which is implemented by a computer infrastructure for controlling the sequential evolution of a resource of at least one discrete event system modelled by a machine having a plurality of states and at least one transition for implementing, when a predefined event occurs, a change of the current state of said resource from a first state to a second state of said plurality of states, said method comprising, in the event of a request to change the current state of said resource, the following steps:
reading, in a memory of said computer infrastructure, a first computer object representing said resource of the discrete event system, said first computer object describing the current state of said resource and comprising a function intended to be executed automatically by said computer infrastructure in the event of a request to change the current state of said resource from the first state to the second state;
executing said function associated with the required state transition from the first state to the second state;
updating the current state of said first computer object and/or generating a second computer object to represent all or part of said resource, the new current state described by the first computer object and/or the new current state described by the second computer object being determined respectively by the result of the execution of said function associated with the required state transition;
recording the first and/or second computer objects in said memory of said computer infrastructure.

Advantageously, such a control method based on the crossing (or firing) of the state transitions promotes the factorization of said function associated with the required state transition between several discrete event systems integrating this same state transition. Such a factorization has the advantage of optimizing and simplifying the control of the discrete event systems.

Various additional features can be provided, alone or in combination:
the first computer object comprises at least one attribute of the resource of the discrete event system, said function being able to carry out a data processing on a value of the attribute;
the function is able to carry out a data processing on an input parameter supplied during the execution of this function;
the function is able to perform machine learning on the basis of predefined data;
the function comprises a condition relating to an item of temporal data;
the method moreover comprises a step of generating said first computer object beforehand;
said memory is a remote distributed database.

Secondly, a computer infrastructure is proposed which is configured to implement the method presented above, this computer infrastructure comprising a remote distributed database for recording or retrieving at least one item of information relating to the first computer object.

Various additional features can be provided, alone or in combination:
said at least one item of information comprises a state with which the first computer object is associated;
said at least one item of information comprises at least one value of an attribute of a resource of the discrete event system in a state with which the first computer object is associated.

Other features and advantages of the invention will become more clearly and more specifically apparent on reading the following description of embodiments, with reference to the accompanying drawings, in which:

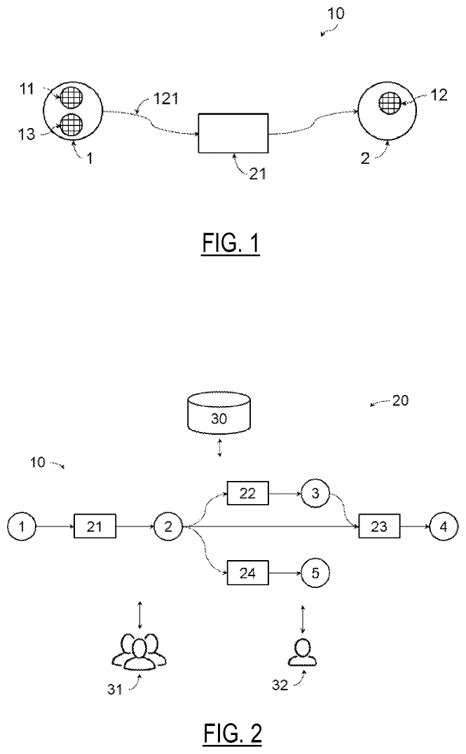

FIG. 1 schematically illustrates states of a machine according to various embodiments controlling the sequential evolution of a resource of a discrete event system;

FIG. 2 schematically illustrates a computer infrastructure implementing a method for controlling the sequential evolution of resources according to such a machine according to various embodiments;

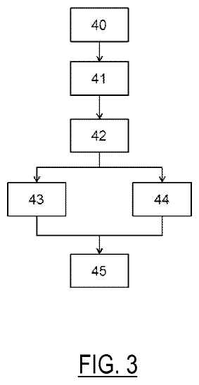

FIG. 3 schematically illustrates steps of a method implemented by a computer infrastructure for controlling the sequential evolution of a resource of at least one discrete event system modelled by a machine.

With reference to FIG. 1, a first and a second state 1, 2 of a machine 10, also called “state machine” 10, modelling a possible sequential evolution of a resource of a discrete event system are shown. A transition 21 makes it possible, when a predefined event occurs, to implement a change of the current state of a resource from a first state 1 to a second state 2. Purely for reasons of simplicity, only two states 1, 2 of the machine 10 are represented in FIG. 1. This machine 10 can, of course, comprise other states as well as transitions between these states for modelling the sequential evolution of the resources of a discrete event system.

A computer object 11 (which could equally be called “digital token 11”, or even “digital structure 11 recorded in a memory”) represents a resource of the discrete event system. This computer object 11 describes the current state of a resource, for example the state 1 of the machine 10. As a function of the respective evolutions of different resources of the discrete event system, one or more computer objects 11-13, associated respectively with said different resources, describe the same current state or different current states of the machine 10. For example, when the discrete event system is an online ticketing system, resources of this system (namely tickets) are represented respectively by one or more computer objects 11-13 possibly associated with different states 1, 2 of the machine 10 (for example “ticket for sale”, “sold ticket”, “refunded ticket”, “ticket for resale”, or “modified ticket”).

In the paradigm of object-oriented programming, the computer object 11 comprises descriptive data, called attributes, of at least one resource of the discrete event system with which the computer object 11 is associated. An attribute can be a single value or a container capable of storing several items of information. An attribute describes the current state of the resource with which the computer object 11 is associated. In another embodiment, a property of the computer object 11 describes the current state of the resource with which this computer object 11 is associated.

The computer object 11 moreover comprises, per possible state transition, at least one function, one method and/or one procedure, indiscriminately referred to as “function” below. This function is able to carry out a data processing or a calculation on the values of the attributes and/or on input parameters, also called “arguments”.

In connection with FIG. 1, at least one function of the computer object 11 is intended to be executed during the crossing (also called “firing”) of the transition 21. This function of crossing the transition 21 comprises a script or a program that can be automatically executed by a computer or more generally by a computer infrastructure requiring the crossing of this transition 21. In other words, the required crossing of the transition 21 when a predefined event occurs causes at least one function of the computer object 11 to be executed by the computer infrastructure.

A function of the computer object 11 is executed during the crossing of the transition 21 by using attributes of the computer object 11 and/or those of another computer object 13, context parameters (for example the date, the time or the geographic location of the execution) and/or by causing another function to be executed, the result of which is considered to be an input parameter, or interactively by using input parameters (i.e. “external” data) supplied during the execution of this function, for example by a user of the system via a human-machine input interface, such as a computer keyboard or a graphical or touch interface, or even a pointing interface.

A function of the computer object 11 can be called up or invoked (i.e. its execution can be caused) by another function of this same computer object 11 or of another computer object. Two computer objects can communicate with each other by sending messages so as to be able to call up a function announced in a first computer object from a second computer object. The computer object 11 is able to participate autonomously in processes involving more than one computer object.

The crossing of a transition 21 translates into the execution of at least one function of the computer object 11. The execution of a function of the computer object 11 during the crossing of the transition 21 causes, in fact, the implementation of the sequential evolution of the resources of the discrete event system.

An oriented arc 121 connecting the first state 1 to the transition 21 (the transition 21 being downstream of the state 1 with respect to the direction of the oriented arc 121) is named or contains a label. This label integrates a reference (for example a name) of the computer object 11. In an embodiment, this label moreover integrates a reference of the function of the computer object 11 intended to be executed during the crossing of the transition 21.

For example, when the discrete event system relates to a system for keeping motor vehicle service records and the computer object 11 represents a service record (possibly encrypted) of a certain motor vehicle associated with the first state 1, a function of this computer object 11 can be an authentication method (possibly with decryption keys) involving the owner of the motor vehicle (for example supplied as an attribute in the computer object 11) and/or the servicing organization (for example supplied as an input parameter) in order to be able to update the service record from the first state 1 (for example a first service in a maintenance plan) to a second state 2 (for example a second service in the maintenance plan later than the first service). Such a function advantageously makes it possible to guarantee that the follow-up of the maintenance of the motor vehicle is complied with whichever application or computer infrastructure requires the sequential evolution of said service record. Attributes of a service record can comprise, for example, one or more identifiers of a motor vehicle, one or more items of information relating to the current owner (and possibly to the previous owners), to the manufacturer and/or to the user of the motor vehicle, a contents (record of actions for example), one or more due dates concerning upcoming actions, rights to read and/or write in the service record.

In another example, when the discrete event system concerns a system for monitoring financial transactions in several steps and the computer object 11 represents a transaction the current state of which is the first state 1, a function of this computer object 11 can be a method for verifying the identity of the customers (process known as “know your customer”, or KYC), in particular within the framework of an anti-money laundering (AML) approach, in order that the transaction can pass (transition 21) from the first state 1 (for example “identity verified”) to a second state 2 (for example “transaction authorized”) of the monitoring process. Such a function advantageously makes it possible to facilitate fundraising by decentralized finance while verifying the KYC-AML directly in the workflow. In this system, the customers can also be represented by computer objects, containing attributes and/or functions, associated with states of a machine modelling a sequential evolution of the statuses of these customers.

In another example, when the discrete event system is a system for invoicing according to different legislations and involving several currencies and the computer object 11 represents an invoice document associated with the first state 1 (“invoice issued”, “awaiting payment”), a function of this computer object 11 can be an up-to-date currency converter, a calculator for a late payment penalty or a procedure peculiar to a certain legislation for passing this invoice document from the first state 1 to a second state 2 (such as “invoice paid”, “invoice validated” or “invoice reminder sent”).

In an embodiment, the computer object 11 comprises a function able to perform machine learning on the basis of data made available to it. These data can be data relating to the current and/or previous states 1, 2 of the resources of the discrete event system, data relating to users of this system, values of one or more attributes of a plurality of computer objects and/or context data. The training data can be supplied in a distributed database and/or be associated with a learning state of the machine 10. Such a machine learning makes it possible, for example, for a function to modify the value of an attribute comprised in the computer object or to select a function to be called up from among a plurality of functions. A machine learning function makes it possible, for example, to adapt the price of an electronic ticket offered for sale on the basis of training data, such as the supply and demand during the crossing of the transition 21, the previous prices, the evolution of demand over time, meteorological data, the presence/absence of competing alternatives for example.

The automatic execution of the function of the computer object 11 during the crossing of the transition 21 makes it possible to update this computer object 11, which represents a resource of the discrete event system, such that the attribute describing the current state of the resource corresponds to the second state 2 of the machine 10. Thus, the new current state of the resource is determined by the automatic execution of the function associated with the transition 21 which has been required and/or of the required state transition. In an embodiment, the result of the function influences the assignment of the computer object 11 to the second state 2 of the machine 10. In another embodiment, the execution of the function of the computer object 11 triggers the generation of a second computer object 12 in order to represent at least a part of said resource. This embodiment is particularly advantageous in particular when this resource is divisible and the produced event only concerns a part of this resource. This second computer object 12 is associated with the second state 2, i.e. the attribute of said second computer object describing the current state of the division of the resource represented by the computer object 11 corresponds to the state 2. When a second computer object 12 is generated following the execution of said function, the first computer object 11 is updated or adapted as a result. This updating relates in particular to the value of an attribute describing the current state of the resource that the computer object 11 represents. For example, when the computer object 11 represents a set of resources of a discrete event system (such as a first plurality of tickets for sale or a second plurality of tickets purchased by a person in an online ticketing system) and the produced event associated with the transition 21 is linked to a subset of said resources (purchase request of a first subset of the first plurality or a cancellation request of a second subset of the second plurality), a new computer object 12 representing this subset of resources is associated with the second state 2. This subset of resources is subtracted from the computer object 11 during an updating of the latter by an instantiation for example.

In an advantageous embodiment, a function of the computer object 11 can use, as input parameter, during the crossing of the transition 21, the value of at least one attribute of one or more other computer objects 13, for example the respective current states of these other computer objects, the number of computer objects associated with a certain state of the machine 10 or, more generally, a value of an attribute of one of these computer objects.

More generally, the execution of a function of the computer object 11 makes it possible to determine how this computer object 11 evolves over the “workflow” or process of evolution of the discrete event system. The execution of this function during the crossing of the transition 21 determines the value of the attribute of the computer object 11 in order that the latter describes the second state 2 instead of the first state 1 or generates another state and associates it with the second state 2. This has the result that the computer object 11 is advantageously active in the sense that the functions associated respectively with the possible current state transitions determine, during a required transition, the next current state of the resource with which it is associated.

The ability of the computer object 11 to control its evolution according to the different states of the machine 10 by crossing its transitions advantageously makes it possible to program a complete workflow of a discrete event system, to ensure that a particular development of the value of the attribute describing the current state of the resource represented by the computer object 11 is adhered to. The evolution of the computer object 11 within the workflow is governed by the functions associated with the different possible state transitions of the resources of the discrete event system.

For example, in the case of a function of the computer object 11 comprising a condition which, during the crossing of the transition 21, is not satisfied (by way of non-limitative examples an expired deadline, an authentication failure or a threshold value being exceeded), the new current state remains the first state 1 and is not modified to correspond to the second state 2 if the condition had been satisfied. In other words, the computer object 11 remains associated with the first state 1 despite the required state transition. A condition relating to an item of temporal data advantageously makes it possible to give a “time” component to the resource represented by the computer object 11 making it possible in particular to give it a lifetime or period of validity.

The use of a function originating from the computer object 11 to cross a transition 21 and to show this computer object 11 the next state with which it will be associated advantageously makes it possible to facilitate the monitoring of the execution by the machine 10.

In an embodiment, at least one item of information relating to the computer object 11 (attributes, input parameters of at least one function, output data generated by at least one function, the evolution of a computer object 11, and/or the state 1, 2 with which this computer object 11 is associated) is recorded in or retrieved from a remote distributed database, in particular a blockchain. A factorization of the states of the machine 10 or, more precisely, of the computer object 11 between several similar discrete event systems is thus possible. A single machine 10 can be used to impose the execution of the same workflow for a plurality of resources. Thus, a typical computer object can be determined as a model. By instantiation of such a model, it is possible to associate computer objects having identical attributes and functions respectively with several resources. Similarly, the programming of a plurality of workflows can be factorized into a single one. For example, a computer object 11 can be designed so as to cover several online sales platforms for goods and/or services, where generally only attributes are to be adapted (seller, goods proposed for sale, currency, prices, or bank details for example). Such a factorization has the advantage of optimizing and simplifying the control of the discrete event systems.

When an event occurs which is associated with the transition 21 of the machine 10 describing the authorized sequential evolution of at least one resource of a certain discrete event system,
the items of information relating to the computer object 11 representing at least one resource of this system in the state 1 are retrieved from the distributed database, said computer object being read or collected from such a database;
the function associated with the required transition 21 is executed by the computer platform requiring said state transition 21, the result of the execution of which determines the value of the new current state of the resource,
once the transition 21 has been crossed, the computer object 11 (or a new computer object 12) is associated with the second state 2, i.e. the attribute describes the current state of the resource is updated in order that it describes the state 2 instead of the state 1; and
the computer object 11 is recorded in the distributed database.

In an illustrative implementation of various embodiments, FIG. 2 describes a graphic representation of a machine 10 comprising a succession of states and transitions associated with events.

The states 1-5 of the machine 10 represent possible evolutions of a plurality of resources of discrete event systems. These systems can belong to different legal or natural persons. By way of non-limitative example, these discrete event systems are online sales systems for goods and/or services or, more generally, any tangible or intangible object which can be offered for sale, such as rights of entry, transport tickets, stock market shares, physical goods, second-hand goods, or cultural goods. In another embodiment, the discrete event systems can relate to systems for online booking or appointment scheduling, online invitations to tender or record keeping for the management of real estate holdings, of qualifications of a user, or of transactions of a bank account.

In an embodiment, an object-oriented modelling of the discrete event systems is performed by means of a Petri net (in particular for workflows containing phenomena of competition, of synchronization, and/or of parallelism), a Grafcet, a UML activity diagram, a Markov chain or an algebraic model.

An implementation in a computer infrastructure 20 of an object-oriented modelling of a plurality of discrete event systems can be obtained, for example, using the SNAKES library (available at the filing date of the present application at https://snakes.ibisc.univ-evry.fr/), any later version thereof, or any other equivalent means. The computer infrastructure 20 comprises the hardware and software that make it possible to implement the machine 10. An implementation of the machine 10 can, for example, be hosted on a web server and/or a server for applications accessible via a website or a mobile application.

For example, a machine 10 describing the authorized sequential evolution of reservation tickets issued by online ticket offices (for example for shows, exhibitions or transport) is translated into functions and attributes of a set of instantiated computer objects from a model. The resources (reservation tickets) represented respectively by said computer objects are first put up for sale (state 1) by sellers 31. The attributes describing the current states of the resources are initialized to describe the state 1. These resources can be heterogeneous from various categories of services belonging to different sellers 31. A computer object 11 representing a ticket in this state 1 can comprise attributes concerning this ticket offered for sale (such as the identity of the seller 31, name of the show, seat number, date of the show, price, promotional offer, charges applicable by the resale, auction or matchmaking platform or by the operator of the computer infrastructure 20). These attributes, together with the computer object 11, can be recorded in a remote distributed database 30 such as a blockchain.

In response to a request to purchase a ticket offered for sale by a buyer 32 (event associated with the transition 21), a function of the computer object 11, the latter being initially associated with the current state 1, is executed during the required crossing of the transition 21 in order to validate a payment and transfer the ownership (updating of the values of the attributes) of the ticket from a seller 31 to the buyer 32. Once this function has been executed, the computer object 11 representing this ticket is associated with the sold ticket state 2. This association, resulting from the updating of the attribute describing the new current state of the source, is recorded (published) in the distributed database 30.

In the case of a postponement of the date of the show for which the purchased ticket is intended (event associated with the transition 22), a modification of the state of the ticket is required. The function associated with the transition 22 is executed automatically. According to the result of said execution, the new state of the ticket is determined. The attribute of the computer object 11 representing this ticket and describing the current state of said resource adopts the value corresponding to the state 3. In the absence of a function (or identity function, “yes function”) associated with a possible transition, no crossing condition for such a transition is required, said transition being systematically accepted by the computer object. As a variant, such an absence of a function can signify an impossibility of satisfying such a request for transition (“no function”).

In response to a request by the buyer 32 desiring to sell their ticket on (event associated with the transition 23 of the machine 10), the validity of the ticket is verified by the automatic execution of the function associated with said possible transition. According to the result of said execution, the attributes of the computer object 11 are updated during the crossing of the transition 23. The ticket is then put in the resale state 4, i.e. the attribute of the computer object 11 describing the current state of the ticket, adopts a new value corresponding to the state 4. In the case of a decision to cancel the show originating from the seller 31 or a request to cancel the ticket originating from the buyer 32 (events associated with the transition 24), a refund function is automatically executed during the required crossing of the transition 24 and the attribute of the computer object 11 describing the current state of the ticket is updated (state 5) to specify that the ticket is a refunded ticket.

The state of the machine 10 described by any computer object (including the computer object 11) can be saved at any time in the distributed database 30 and reloaded, during a subsequent reading/collection of said computer object in order to continue the sequential evolution of the resource presented by said computer object, in particular in response to a new request to modify the state of the resource following an occurrence of an event associated with any one of the possible transitions 21-24.

The computer infrastructure 20 here designates the hardware and the software (such as one or more web servers (i.e. servers accessible by means of browsers), one or more application servers or equivalent) making it possible to provide sufficient processing power to implement the machine 10 translated into the automatic execution of the functions associated with the possible transitions conveyed by the computer objects and of reading/collecting or recording these latter in the, advantageously distributed, database 30.

Such hardware of a computer infrastructure 20 can advantageously be in the form of one or more microcontrollers or microprocessors. This or these latter cooperate in particular with a data memory in order to record or read data created by the implementation of said machine as well as operating parameters, or more generally all produced or prerecorded data, whether they consist of intermediate data or results. Such processing means moreover contain a program memory in order to record instructions of a computer program the execution of which causes the implementation of methods. By “data or program memory” is meant any volatile or, advantageously, non-volatile computer memory. A non-volatile memory is a computer memory the technology of which makes it possible to retain its data in the absence of an electrical power supply. It can contain data resulting from inputs, calculations, measurements and/or program instructions. The main non-volatile memories currently available can be electrically writable and/or erasable. They are based on the technologies of EPROM (“Erasable Programmable Read-Only Memory”), EEPROM (“Electrically Erasable Programmable Read-Only Memory”), flash, SSD (“Solid-State Drive”), etc. The “non-volatile” memories are distinguished from the memories called “volatile”, the data of which are lost in the absence of a power supply. The main volatile memories currently available are of the types: RAM (“Random Access Memory”), DRAM (“Dynamic Random Access Memory” designating a dynamic random access memory requiring regular refreshing), SRAM (“Static Random Access Memory” designating a static random access memory requiring such refreshing in the event of low power), DPRAM or VRAM (“Dual Ported Random Access Memory” and “Video Random Access Memory” designating memories particularly suitable for video), etc. A “data memory”, in this document, can be volatile or non-volatile.

Advantageously, a computer infrastructure 20 supporting such an implementation of the machine 10 equipped with a library of computer objects 11 (integrating for example payment, condition verification, authentication, calculation, training or validation functions) describing various behaviours of discrete event systems makes it possible to support and manage several discrete event systems simultaneously.

The result of this is that the computer infrastructure 20 is arranged to implement a method for controlling the sequential evolution of resources of at least one discrete event system modelled by the machine 10. This method comprises:
a step of generating 40 at least one first computer object 11 representing a resource of the discrete event system beforehand, this computer object 11 describing the current state 1 of said resource and comprising a function intended to be executed automatically by the computer infrastructure 20 in the event of a request to change the current state 1 of said resource from the first state 1 to a second state (2);
in the event of a request to change the current state of said resource, a step of reading 41, in a memory of the computer infrastructure 20, the first object 11;
a step of executing 42 said function associated with the required state transition from the first state 1 to the second state 2 during the crossing of the transition 21;
a step of updating 43 the current state of the first computer object and/or a step of generating 44 a second computer object 12 to represent all or part of said resource, the new current state described by the first computer object 11 and/or the new current state described by the second computer object 12 being determined respectively by the result of the execution of said function associated with the required state transition;
a step of recording 45 the first and/or second computer objects 11, 12 in said memory of the computer infrastructure 20.

This computer implementation of a discrete event system is focused on the crossing (or firing) of the state transitions of the machine 10 modelling the sequential evolution of at least one resource of the discrete event system.

1. Method, implemented by a computer infrastructure, for controlling the sequential evolution of a resource of at least one discrete event system modelled by a machine having a plurality of states and at least one transition for implementing, when a predefined event occurs, a change of the current state of said resource from a first state to a second state of said plurality of states, said method comprising, in the event of a request to change the current state of said resource, the following steps:
reading, in a memory of said computer infrastructure, a first computer object representing said resource of the discrete event system, said first computer object describing the current state of said resource and comprising a function intended to be executed automatically by said computer infrastructure in the event of a request to change the current state of said resource from the first state to the second state;
executing said function associated with the required state transition from the first state to the second state;
updating the current state of said first computer object and/or generating a second computer object to represent all or part of said resource, the new current state described by the first computer object and/or the new current state described by the second computer object being determined respectively by the result of the execution of said function associated with the required state transition;
recording the first and/or second computer objects in said memory of said computer infrastructure.

2. Method according to claim 1, in which the first computer object comprises at least one attribute of the resource of the discrete event system, said function being able to carry out a data processing on a value of the attribute.

3. Method according to claim 1, in which the function is able to carry out a data processing on an input parameter supplied during the execution of this function.

4. Method according to claim 1, in which the function is able to perform machine learning on the basis of predefined data.

5. Method according to claim 1, in which the function comprises a condition relating to an item of temporal data.

6. Method according to claim 1, comprising it moreover comprises a step of generating said first computer object beforehand.

7. Method according to claim 1, in which said memory is a remote distributed database.

8. Computer infrastructure configured to implement the method of claim 1, this computer infrastructure comprising a remote distributed database for recording or retrieving at least one item of information relating to the first computer object.

9. Computer infrastructure according to the preceding claim 8, in which said at least one item of information comprises a state with which the first computer object is associated.

10. Computer infrastructure according to claim 8, in which said at least one item of information comprises at least one value of an attribute of a resource of the discrete event system in a state with which the first computer object is associated.
